(19) United States
(12) Patent Application Publication
(10) Pub. No.: US 2009/0127320 A1
(43) Pub. Date: May 21, 2009

(54) REFRIGERATION PURGING ADAPTOR

(76) Inventor: David W. McKee, JR., Bellingham, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 12/247,295

(22) Filed: Oct. 8, 2008

Related U.S. Application Data
(60) Provisional application No. 60/989,024, filed on Nov. 19, 2007.

(51) Int. Cl. B23K 35/38; F16L 55/18

(52) U.S. Cl. 228/219; 285/39

(57) ABSTRACT

An adapter configured to enable a user to quickly and easily couple a fluid supply source to a pipe extending from a system to be brazed without requiring any modification or marring to the pipe. The adapter forming a substantially air-tight seal without requiring any bonding or adhesives. In one form the adapter comprises an access stem fitting on one end, and a step or conic adapter on another end. A method for using this device is also disclosed where in one form, the fitting is connected to a fluid source, the fitting is connected to the system to be brazed or welded, fluid is provided, and the system is brazed or welded.

### RELATED APPLICATIONS

This application claims priority benefit of U.S. Provisional Ser. No. 60/989,024, filed Nov. 19, 2007, incorporated by reference.

### BACKGROUND OF THE DISCLOSURE

a) Field of the Disclosure

The embodiment of this disclosure relates to the field of brazing, soldering, and welding, tubing, especially copper pipe, in refrigeration systems to reduce the formation of “black scale”.

b) Background Art

The benefits of using dehydrated nitrogen while making brazed joints in a refrigeration system are well known in the art. Many practitioners in this art have advocated the use of nitrogen during refrigerant line brazing for more than 20 years.

When brazing (a soft form of welding) is conducted on copper tubing or any other copper surface, a significant portion of the copper will oxidize in the presence of oxygen resulting in a significant quantity of black scale (oxidized copper). One standard procedure for eliminating this black scale (which is very detrimental to the normal operation of refrigerant line operation) is to subject the interior portion of copper tubing which is to be brazed with a low-pressure, low-volume supply of nitrogen. For example, a steady flow of nitrogen, at about five PSIG will result in a significant, if not total, reduction in the amount of black scale produced during brazing. This procedure is often utilized where copper is joined to copper or sometimes when copper is joined to other materials such as brass. A heat source, normally over 2000° F. often through the use of a torch kit, is provided which is applied to the copper tubing and to a brazing alloy. The brazing alloy melts, and upon cooling effectively becomes a part of the piping material. Silver alloy brazing rod with a 15% silver content melts and flows at roughly 1500° F. The temperature between 1500° F. and 20,000° F. is high enough to cause a chemical reaction between the atmospheric oxygen inside the pipe and the interior surface of the pipe itself. The resulting black scale is cupric oxide (CuO). Cupric oxide is formed on a very unstable layer, approximately 0.002 inches thick, slightly less than the thickness of common newspaper. This layer of oxidized copper quickly separates and may circulate through the refrigeration system as a contaminant. Physical damage can occur at check valves, and solenoid, or switchover valves. Compressor components are machined to extremely close tolerances; this paper-thin scale can damage these parts and others. Prior art attempts to pump out the system are not effective as this system does not remove solids from the piping system. Other prior art attempts include “blowing out” a system which also is ineffective in removing this black scale.

A few refrigeration systems have been provided with an access stem fitting which allows for direct attachment of a fluid source. However, many of the refrigeration systems do not provide such an access stem fitting for ease of providing a dehydrated nitrogen while brazing.

Prior art solutions to attaching the nitrogen source to the tubing of an air condition or refrigeration system involve normally positioning the end of the nitrogen source tubing to the end of an access tubing of the air condition or refrigeration system. At this point, a length of duct tape would be wrapped around the tubing and assembly, essentially closing off the system, such that the nitrogen would be injected into the refrigeration system, and upon which time brazing could be accomplished without producing black scale. This process has negative side effects, including the residue of the duct tape, and the time involved in attaching the apparatus, and detaching the duct tape when brazing was accomplished. Furthermore, the adhesive residue left over from duct tape negatively interferes with the refrigerant utilized, as well as in a brazing compound that should be desired on that surface.

### SUMMARY OF THE DISCLOSURE

Disclosed herein is a coupling mechanism operatively configured to attach a fluid supply line to a system to be brazed. This is desired, for example, when a fitting or pipe is to be brazed to another fitting or section of pipe. In one form the adapter comprises an access stem fitting which is configured to fixedly and removably couple to a fluid supply system. The access stem fitting in one form being a male or female quick connect gas fitting, which couples to a mating female or male fitting on the fluid supply line. The coupling mechanism in one form includes an adapter portion, which is coupled to the access stem fitting. An adapter portion is also provided and is operatively configured to frictionally and removably couple to a pipe or fitting extending from the system to be brazed. Thus, the adapter portion can be quickly and easily attached to and removed from the fitting or pipe without deforming, or marking the fitting or pipe, and without the use of any adhesives. The adapter portion is thus operatively configured to leave no substantial mark or residue upon the fitting or pipe which extends from the system to be brazed.

In one form, the coupling mechanism further comprises a piping portion which extends from the first engagement surface of the access stem fitting. This piping portion connects the access stem portion, to the adapter portion.

In another form, the adapter portion comprises a plurality of unique segments operatively configured to correlate to the diameter of the pipe extending from the system to be brazed. Thus, the adapter portion can be fitted to pipes having a wide range of interior and/or exterior diameters. For example, in one embodiment, the adapter potion comprises unique inner diameters at least one of which is operatively configured to correlate to the outer diameter of the pipe extending from the system to be brazed.

In one form, the access stem portion comprises a quick-disconnect gas fitting as previously mentioned. The access stem portion allows the adapter to couple to gas supply sources, such as Nitrogen, which is commonly used as a gas to eliminate the formation of black scale.

The piping portion previously discussed may comprise a substantially rigid pipe structure. This makes the adapter easier to use in some instances, and can provide a surface which is easy to grasp. The piping portion may be omitted in one form, such that the access stem fitting attaches directly to the adapter portion.

In another form, the adapter portion comprises a frustoconical surface operatively configured to engage the diameter of the pipe extending from the system to be brazed. This allows the adapter portion to couple to any pipe within a range limited by the largest and smallest diameter of the surface of the adapter.

For example, the adapter portion may comprise a frustoconical inner surface operatively configured to engage the outer diameter of the pipe extending from the system to be brazed.

In one form, the coupling mechanism is operatively configured to provide a substantially airtight seal between the adapter portion, and the pipe extending from the system to be brazed. This hinders the gas from venting prematurely to the outside air. The adapter portion in one form may provide a seal sufficient to allow positive pressure within the system to overcome the frictional force of the adapter upon the pipe or fitting and “push” the adapter off the fitting when the brazing operation is complete. A substantially airtight seal may be provided by frictional contact between a surface of the adapter portion, and a surface of the pipe extending from the system to be brazed, without marring the surface of the pipe or leaving any residue upon the surface of the pipe. The coupling mechanism in one form provides a substantially airtight seal capable of holding positive interior pressure up to about 6 psi.

Also disclosed herein is a method for reducing the oxide formed in a length of pipe while brazing or welding. In one form this involves the steps of: 1) providing a coupling mechanism which comprises an access stem portion coupled to an adapter portion; 2) fixedly and removably coupling the access stem portion to a source of fluid wherein the fluid is selected from the fluids which inhibit the formation of oxides during brazing or welding; 3) fixedly and removably coupling the adapter portion to a portion of pipe extending from the system to be brazed; and 4) then causing fluid to flow from the source of fluid through the coupling mechanism and into the system to be brazed. The process may also include a frictional, non-compressive engagement between the adapter portion and the portion of pipe extending from the system to be brazed. The process may also include a substantially airtight seal capable of holding internal positive pressure up to about 6 psi.

### BRIEF DESCRIPTION OF THE DRAWINGS

FIG. 1 is a perspective view of one embodiment of a female, stepped version the disclosure.

FIG. 2 is a perspective view of another embodiment of a female, conic version of the disclosure.

FIG. 3 is a perspective view of one embodiment of a male, stepped version of the disclosure.

FIG. 4 is a highly schematic diagram of a refrigeration system attached to one embodiment of the disclosure.

### DESCRIPTION OF THE PREFERRED EMBODIMENTS

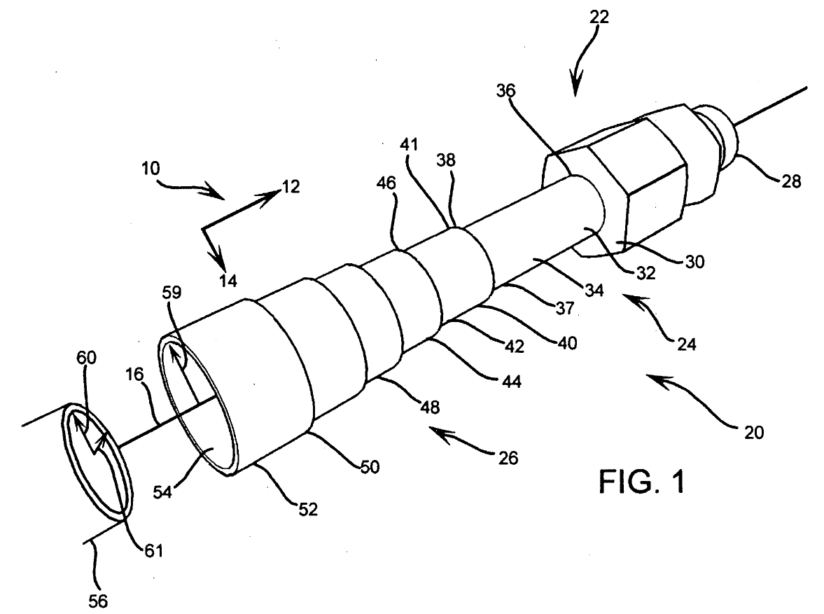

Before beginning, an axes system 10 is disclosed and shown in FIG. 1, comprising a longitudinal axis 12, and a radially outward axis 14 which points in a direction from a longitudinal axis 16 toward the outer surface 52 of the apparatus. These axes and orientations are for ease of understanding, and are not intended to be limiting.

Disclosed herein is a coupling mechanism 20. The coupling mechanism in general comprises three separate portions. The first being an access stem portion 22, the second being a piping portion 24 and the third being an adapter portion 26.

The access stem portion 22 in one form has a service end 28 which may be a threaded portion or may be an access stem fitting of a type known in the art for coupling to a nitrogen source. Often a length of flexible tubing will be provided between the access stem fitting and the fluid supply. One such access stem fitting is described in U.S. Pat. No. 4,613,112 incorporated herein by reference. This is only one example of the fittings and equivalents which could be used. The flexible tubing in one form is coupled to a regulator and or a valve, which is coupled in turn to a nitrogen source. Various embodiments of this arrangement and multiple features can be incorporated. The second, or outflow end 30 of the access stem portion 22 is configured to accept the piping portion 24. The piping portion 24 in one form is a short section of air condition grade, or refrigeration grade copper tubing having a first end 32 which is connected to the outflow end 30 of the access stem portion 22. The piping portion 24 has an outer surface 34 which may be configured to be brazed 36 or connected by other methods, such as a threaded section, at the first end 32 to the outflow end 30 of the access stem portion 22. The piping portion 24 also has an interior surface defining a void which allows passage of the nitrogen or other fluid from the access stem portion 22 to the adapter portion 26.

The second end 37 of the piping portion 24 in one form is coupled by way of brazing 38 or other methods, such as a threaded section, to the adapter portion 26. The adapter portion 26 in one form comprises a plurality of adaptor segments each having a different internal diameter (ID). The first, or smallest segment 40, is connected at a first end 41 to the piping portion 24 as previously discussed. The second end 42 of the smallest segment 40 in one form is coupled to a second segment 44. The second segment 44 has a larger internal diameter than the smallest segment 40. In one form, the internal diameter of the second segment 44 has the same dimension as the outer portion of the smallest segment 40. In this way the smallest segment 40 and the second segment 44 may be easily coupled by way of brazing 46 or other methods as previously discussed. These segments may also be formed as a unitary structure. The second segment 44 in one form is coupled in a similar manner to a third segment 48 which is coupled to other segments until a largest segment 50 is coupled to the previous segment. The largest adapter 50 has an outer surface 52 and an inner surface 54. The inner surface 54 defines the largest tubing 56 that the coupling mechanism 20 can couple to. The tubing 56 is coupled in turn to the refrigeration system.

In one form, the segments 40, 44, 48, and 50 have a range of internal diameters (internal radius of segment 50 is shown at 59) of the first or smallest segment 40 to the largest adapter 50 ranging from ¼″ ID, ⅜″ ID, ⅝″ ID, ¾″ ID. It is well known that these are some of the common outer diameters for air-condition grade tubing; however, it would be obvious to change this particular series, for example, to metrics, or to air-condition tubing having larger or smaller external diameters (see radius 60).

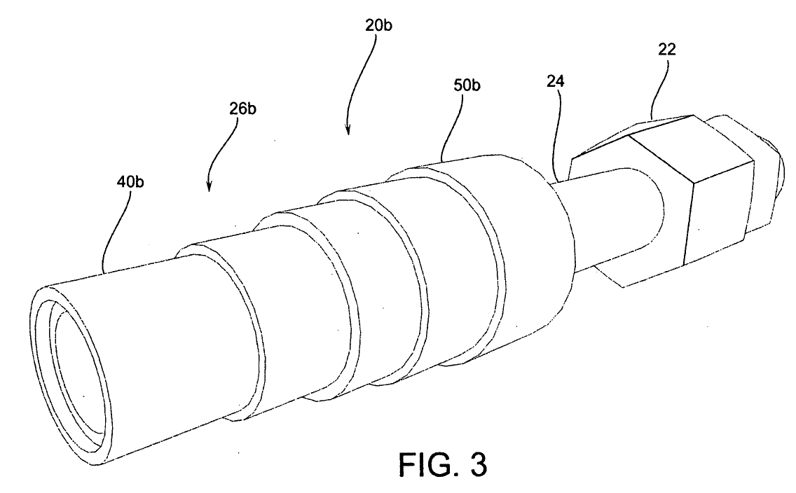

FIGS. 1 and 3 show an adapter portion 26 and 26b wherein each of the segments are co-centric around a central axis. Other embodiments could be equally utilized, for example, one side or edge of each of the steps could be aligned and the stepped portion being offset from a longitudinal axis.

In one form, the apparatus has a range overall length from 3″ up to 10″. A range of 4″ to 8″ is in a preferred range. As is obvious from this preferred range, it would be very simple to carry and store the apparatus while a practitioner is brazing a series of connections in a refrigeration system. While not in use it would fit within a practitioner's pocket.

In another form, the piping portion 24 could be a relatively long, flexible member, in one form up to 12 inches in length or more. A longer, flexible arrangement may be useful in confined areas or for other purposes. Thus, the access stem portion 22 would still be coupled to the fluid source, which could then be positioned at a distance from the tubing 56. The piping portion 24 could span a longer or nonlinear path between the access stem portion 22 and the adapter portion 26.

Another embodiment 20b shown in FIG. 3 is to have the adapter portion 26b reversed such that the largest adapter 50b is coupled to the piping portion 24, and the smallest adapter 40b is positioned furthermost from the access stem portion 22. In this embodiment the adapter portion would fit within the inner diameter (radius 61) of the refrigeration tubing 56.

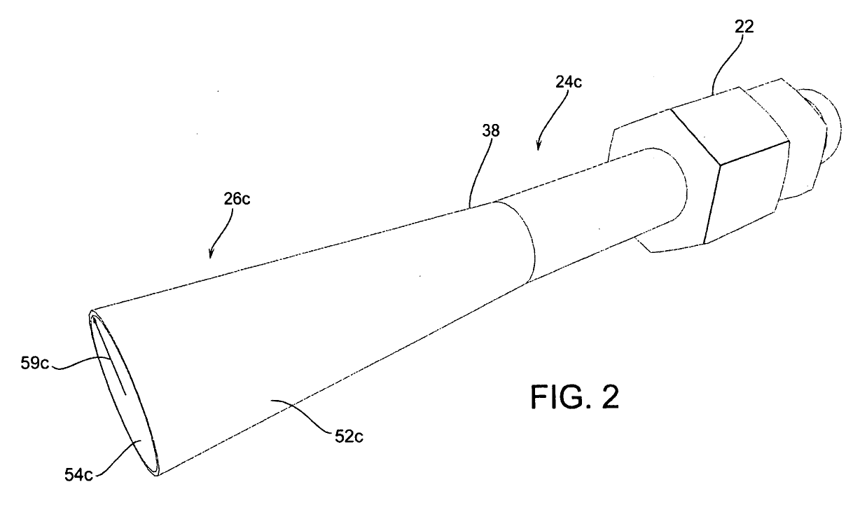

In another form, as shown in FIG. 2, the adapter portion 26c substantially forms a cone which will allow a much wider range of connections to refrigeration tubing 56. As in the previous embodiment, the adapter portion 26c is coupled to a piping portion 24c by way of brazing 38 or similar methods such as a threaded section. The piping portion 24c would be coupled to an access stem portion 22, as previously shown. In this embodiment the tubing 56 would fit within the adapter portion 26c and substantially engage the inner surface 54c of the adapter portion 26c. The system could then be brazed after nitrogen has been supplied to the system. This form of the disclosure would have the advantage that any tubing 56 having an outer diameter (radius 60) smaller than the largest diameter (radius 59c) of the inner surface 54c of the adapter portion 26c would fit within the adapter portion 26c.

As with the previous example, the conical adapter of FIG. 2 could be reversed such that the outer surface 52c of the adapter portion 26c would fit within the inner surface of the refrigerant tubing 56. To enhance the fit between these two portions, a malleable surface may be provided on the interior/exterior surface of the fitting, such as soft aluminum, a polymer, closed-cell foam, or an equivalent structure.

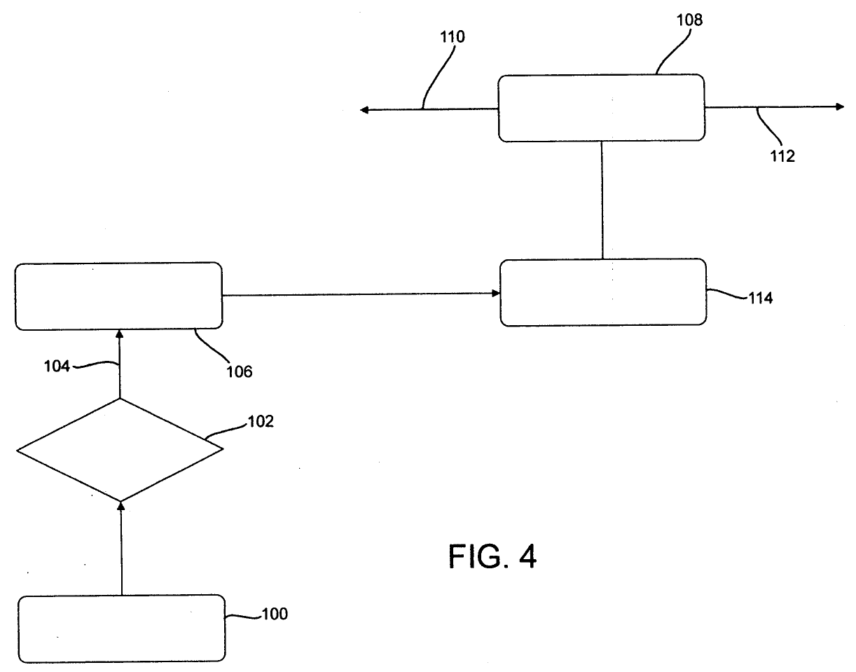

Looking now to FIG. 4, a highly schematic diagram is shown to further explain how this refrigeration purging adapter can be utilized. As shown, a fluid source 100 is shown, which may be coupled to a valve or regulator 102. The fluid source may be a pressurized tank of fluid such as nitrogen gas or an equivalent structure. The fluid source is coupled by way of the valve or regulator 102 and a section of hose 104 to the refrigeration purging adapter 106. In many instances, it will be desired that the hose 104 be a flexible member capable of holding pressurized fluid.

A refrigeration system 108 is also shown comprising a plurality of hoses 110 and/or fittings 112. When it is desired to braze or otherwise couple one of these portions 114, the refrigeration purging adapter 106 is coupled to the portion 114 at which point the valve or regulator 102 can be engaged allowing fluid to flow from the fluid source 100, through the purging adapter 106, to the portion 114 to be brazed. The term portion to be brazed 114 is broadly defined as a hose 110 or fitting 112 which may need repair, replacement, or which may need an additional hose or fitting coupled thereto. Until the brazing is completed, the brazing coupling 108 will very likely not form a substantially airtight seal and so it may not be necessary to provide an outlet for the fluid downstream from the brazing coupling.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A coupling mechanism operatively configured to attach a fluid supply line to a system to be brazed, the adapter comprising:
a. An access stem fitting configured to fixedly and removeably couple to a fluid supply system;
b. an adapter portion, coupled to the access stem fitting operatively configured to frictionally and removably couple to a pipe extending from the system to be brazed, and
c. wherein the adapter portion is operatively configured to leave no substantial mark nor residue upon the pipe extending from the system to be brazed.

2. The coupling mechanism as recited in claim 1, further comprising a piping portion extending from the first engagement surface.

3. The coupling mechanism as recited in claim 1, wherein the adapter portion comprises a plurality of unique segments operatively configured to correlate to the diameter of the pipe extending from the system to be brazed.

4. The coupling mechanism as recited in claim 3, wherein the adapter portion comprises unique inner diameters at least one of which is operatively configured to correlate to the outer diameter of the pipe extending from the system to be brazed.

5. The coupling mechanism as recited in claim 1, wherein the access stem portion comprises a quick-disconnect gas fitting.

6. The coupling mechanism as recited in claim 2, wherein the piping portion comprises a substantially rigid pipe structure.

7. The coupling mechanism as recited in claim 1, wherein the adapter portion comprises a frustoconical surface operatively configured to engage the diameter of the pipe extending from the system to be brazed.

8. The coupling mechanism as recited in claim 7, wherein the adapter portion comprises a frustoconical inner surface operatively configured to engage the outer diameter of the pipe extending from the system to be brazed.

9. The coupling mechanism as recited in claim 1, wherein the coupling mechanism is operatively configured to provide a substantially airtight seal between the adapter portion and the pipe extending from the system to be brazed.

10. The coupling mechanism as recited in claim 9, wherein the substantially airtight seal is provided by frictional contact between a surface of the adapter portion, and a surface of the pipe extending from the system to be brazed without marring the surface of the pipe or leaving any residue upon the surface of the pipe.

11. The coupling mechanism as recited in claim 9, wherein the substantially airtight seal is operatively configured to hold positive interior pressure up to about 6 psi.

12. The coupling mechanism as recited in claim 1, wherein the overall length of the coupling mechanism is between 4″ and 8″

13. A method for reducing the oxide formed in a length of pipe while brazing or welding comprising the steps of:
a. providing a coupling mechanism which comprises an access stem portion, coupled to an adapter portion;
b. fixedly and removably coupling the access stem potion to a source of fluid;
c. wherein the fluid is selected from the fluids which inhibit the formation of oxides during brazing or welding;
d. fixedly and removably coupling the adapter portion to a portion of pipe extending from the system to be brazed; and
e. causing fluid to flow from the source of fluid, through the coupling mechanism, and into the system to be brazed.

14. The method as recited in claim 13, wherein the step of fixedly and removably coupling the adapter portion to a portion of pipe extending from the system to be brazed comprises a frictional, non-compressive engagement between the adapter portion and the portion of pipe extending from the system to be brazed.

15. The method as recited in claim 13, wherein the step of coupling the adapter forms a substantially airtight seal capable of holding internal positive pressure up to about 6 psi.
